(19) United States
(12) Patent Application Publication
(10) Pub. No.: US 2003/0150693 A1
(43) Pub. Date: Aug. 14, 2003

(54) Method and device for producing optical data carriers

(75) Inventor: Klaus Peter Weidenhaupt, Munchen (DE)

Correspondence Address: Henry M. Feiereisen, Suite 3220, 350 Fifth Avenue, New York, NY, 10118, US

(73) Assignee: KRAUSS-MAFFEI KUNSTSTOFFTECHNIK GMBH, Munchen (DE)

(21) Appl. No.: 10/350,909

(22) Filed: Jan. 24, 2003

(30) Foreign Application Priority Data
Jan. 24, 2002 (DE) 102 02 559.2

(51) Int. Cl. B65G 47/00

(52) U.S. Cl. 198/339.1

(57) ABSTRACT

The invention relates to a method and a device for producing optical data carriers using substrates. The substrates are transported by a linear transport system, which operates in a stepwise fashion, from injection molding machines via processing stations to drying stations. To shorten the processing time for the substrates, the transport device (walking beam) is operated with a sequence of single and double or multiple steps.

### CROSS-REFERENCES TO RELATED APPLICATIONS

This application claims the priority of German Patent Application, Serial No. 102 02 559.2, filed Jan. 24, 2002, pursuant to 35 U.S.C. 119(a)-(d), the disclosure of which is incorporated herein by reference.

### BACKGROUND OF THE INVENTION

The present invention relates, in general, to a method for producing optical data carriers, such as DVD, CD, as well as writable optical data carriers, such as CD-R, DVD-R, OBC-R and the like.

Such methods and devices are known from WO 01/63605 A1, where two different substrates are produced in two injection molding machines and are alternatingly placed onto a linear, stepwise operating transport system which feeds the substrates step-by-step via a metallizing station and a coating station to a joining station where the substrates are joined. The substrates are processed in pairs, and the transport system is operated in double steps, i.e., at each double steps the substrates are moved by two positions of the linear transport system.

This transport system represents a so-called “walking beam” with a stationery horizontal and a movable vertical transport beam (representing the “beam”) and a movable horizontal and stationery vertical transport frame (representing the “walk”) with two beam-like elements which extend parallel to the transport frame along the sides of the transport frame. The transport beam includes a linear arrangement of support elements with centering pins, wherein the substrates can be placed on the support elements and supported in their central region. The transport frame has contact surfaces located on the beam-like elements for supporting the peripheral region of the substrates. The transport beam is lowered for transporting the substrates, so that the substrates make contact with the support surfaces while the centering pins are no longer in contact with the substrates. The transport frame is subsequently displaced by a distance corresponding to two positions, and the transport beam is raised to again receive the substrates. As a result, the substrates are moved on the transport beam by two positions. The transport frame is then moved backwards to begin a new step. This method requires a displacement by two positions because the substrates are processed in pairs; walking beam transport systems typically move the substrates only by a single position at each step. Further details of the transport system are described in the aforementioned reference.

With the aforedescribed method and/or device, the two substrates can always be consistently finished at the proper production cycle and made available at the joining station. However, this transport system includes two loading positions and two unloading positions, so that the entire system has to be extended by two positions; also required are special handling devices and a longer processing time for the substrates.

Alternatively, the substrates could be processed individually, which would obviate the need for the special handling devices, and the transport system could be operated in single steps, eliminating the additional loading and unloading positions. This, however, further lengthens the processing time for the articles.

It would therefore be desirable and advantageous to provide an improved method and a more compact device to obviate prior art shortcomings and to realize short processing time for the articles.

### SUMMARY OF THE INVENTION

An exemplary method and device according to the invention for the manufacture of data carrier substrates employs two different processing stations.

According to one aspect of the invention, a method is disclosed for producing optical data carriers with substrates produced in two injection molding machines. The method includes the steps of transporting the substrates from the injection molding machines by a single linear transport system, which operates in a step-wise fashion, to a first processing station for processing a first substrate, to a second processing station for processing the second substrate, and to at least one third processing station for further processing the first and second substrates, wherein the transport system is operated by a sequence of single, double or multiple steps.

According to another aspect of the invention, a device for transporting substrates for producing optical data carriers which are made of two substrates produced by two injection molding machines, includes a linear transport system operating stepwise for transporting the substrates from the injection molding machines to a first processing station, in which the first substrates are processed, to a second processing station, in which the second substrates are processed, to at least one additional processing station, in which the substrates are further processed. The transport system is configured for operation with a sequence of single and double or multiple steps.

Embodiments of the invention may include one or more of the following features. The first and the second processing stations can be arranged sequentially, as viewed in the transport direction of the transport system, wherein a first substrate is loaded in the transport system, a single step is performed followed by a double step, a second substrate is loaded in the transport system, and a double step is performed followed by a single step.

More particularly, the transport system can have six positions for receiving substrates and the transport system can be loaded and unloaded in four repeating operating cycles. A first position herein represents a loading position, a second position represents a withdrawal position for the first processing station, a third position represents a loading station from the first processing station, a fourth position represents a withdrawal position for the second processing station, a fifth position represents a loading position from the second processing station and a sixth position represents a withdrawal position. In a first operating cycle the first and third positions are loaded, the fourth and sixth positions are unloaded, followed by a single step. In a second operating cycle the second position is unloaded, followed by a double step. In a third operating cycle, the first position is loaded and the sixth position is unloaded, followed by a double step, and in a fourth operating cycle, the fifth position is loaded, followed by a single step.

The transport system can be a walking beam system and can include two coating stations, which can be are arranged on different sides of the transport system. The processing stations can be sequentially arranged in a transport direction of the transport system.

As seen from the above, the linear transport system is operated during the transport with a combination of single and double or multiple steps, i.e., the substrates are moved along the transport system by either a single position or by two or more positions. The processing time can be significantly reduced as compared to a device that transports only in single steps.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a top view a device according to the present invention for transporting substrates in the manufacture of optical data carriers;

FIG. 2 shows details of the operating cycles of the device; and

FIGS. 3 to 6 show graphically the occupancy of the various positions on the linear transport device during the operating cycles of FIG. 2.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way.

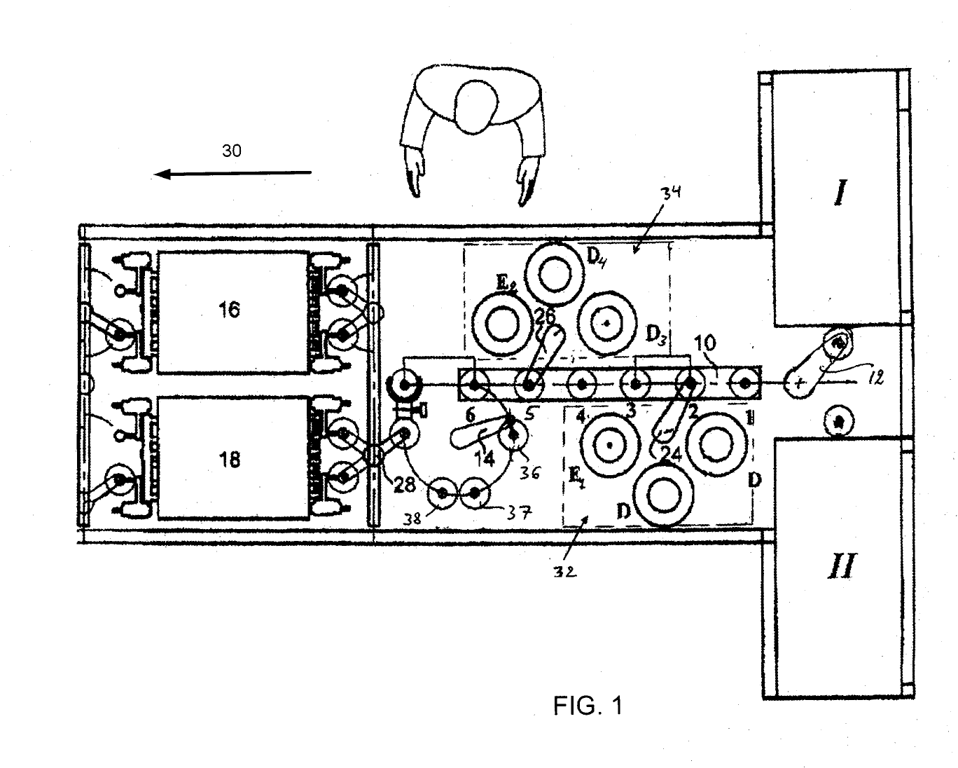

Turning now to the drawing, and in particular to FIG. 1, there is shown a top view a device according to the present invention for producing optical data carriers, such as DVD, CD, CD-R, DVD-R, OBC-R and the like. In a first injection molding machine I first substrates (B substrates) are produced in a conventional manner, and likewise second substrates (A substrates) are produced in a second injection molding machine II. The substrates are placed by a handling device 12 (P&P; “pick and place”) at a loading position 1 of a linear transport device 10 of the aforedescribed walking-beam type that operates in discrete steps. The exemplary transport device 10 includes a total of 6 positions, i.e., in addition to the loading position 1, an unloading position 2 for the A substrates, a loading position 3 for the A substrates, an unloading position 4 for the B substrates, a loading position 5 for the B substrates, as well as a withdrawal position 6. The substrates, after traversing the entire transport path 1-6 of the transport device 10, are withdrawn from the withdrawal position 6 by a transfer device 14 and handed over to another transfer device 28, which delivers the substrates to one of two drying stations 16, 18 where the substrates are dried. The drying stations 16, 18 can have multiple parallel paths. The dried A and B substrates are transferred after drying to additional stations (such as joining stations; not shown) for further processing.

Also indicated in the path of transfer device 14 are optional units for quality control measures, such as a scanner 36 that classifies the substrates into “acceptable” and “unacceptable”, and a spindle 37 capable of withdrawing, for example, acceptable substrates, and another spindle 38 for removing unacceptable substrates (scrap) from the process.

Arranged along the side of the linear transport device 10 are processing stations 32 and 34, wherein A substrates are processed in the processing station 32 and B substrates are processed in the processing station 34. This is done by removing the A substrates with a handling device 24 from the corresponding position 2 and likewise removing the B substrates with a handling device 26 from the corresponding position 4, respectively. The A substrates are then coated with a dye in processing units D1 and D2, whereas the B substrates are coated with a dye in processing units D3 and D4. Corresponding processing units E1 and E2 are provided for the A substrates and the B substrates, respectively, where the edges of the corresponding A and B substrates can be cleaned, for example by a rinsing step. After the A substrates have passed through the associated processing units D1 and D2 and the processing unit E1, they are placed on the loading position 3. Likewise, the B substrates are placed on the loading position 5 after having passed through the associated processing units D3 and D4 and the processing unit E2.

As mentioned above, the linear transport device 10 operates in steps, namely in single steps whereby each of the substrates is displaced by a single position (for example, 1-2 and 3-4) in the direction of the arrow 30, and in double steps (for example, 4-6) whereby the substrates are displaced by two positions in the same direction. Between these steps are operating cycles during which substrates are placed onto or removed from the transport beam of the transport device 10. A substrate traverses the transport path in one loop consisting in the present example of four operating cycles, which are each separated by single or double steps.

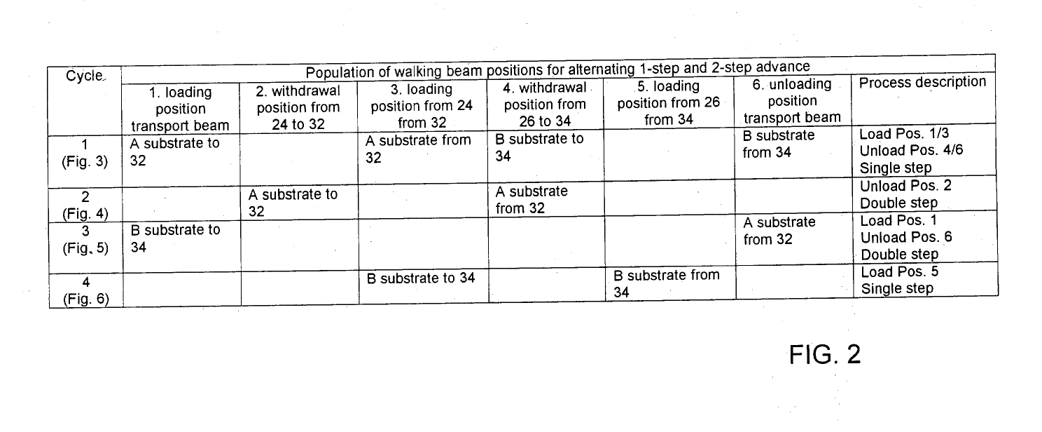

As seen from FIG. 2, in a first cycle, the transport device is simultaneously loaded and unloaded at four of the six positions, namely positions 1, 3, 4 and 6. An A substrate is transferred from the injection molding machine I to position 1 of the transport device 10; another A substrate, after being processed in processing station 32, is placed on position 3; a B substrate is removed from position 4 for processing in the processing station 34; and a processed B substrate is removed from position 6 for transfer to one of the drying stations 16, 18. This first cycle is followed by a single step in which A substrates are transported from position 1 to position 2, and from position 3 to position 4, respectively.

In a second cycle, the A substrate is removed from position 2 for processing, the processed A substrate remains in position 4. This cycle is followed by a double step, in which the A substrate is moved from position 4 to position 6.

In a third cycle, a B substrate is transferred from the injection molding machine II to position 1, and the A substrate is removed from position 6. This is followed by a double step in which the B substrate is moved from position 1 to position 3.

In a fourth cycle, the B substrate remains in position 3, while the processing station B places a processed B substrate at position 5. This is followed by a single step in which the B substrates are transported from position 3 to position 4, and from position 5 to position 6, respectively. This process loop is then repeated, starting with the aforedescribed first cycle.

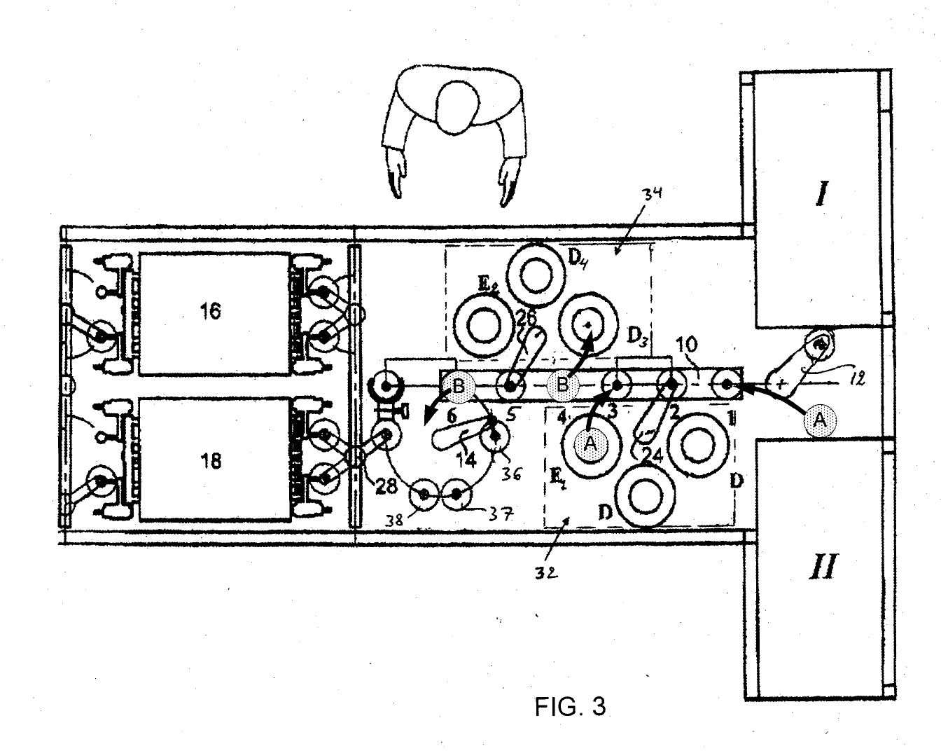

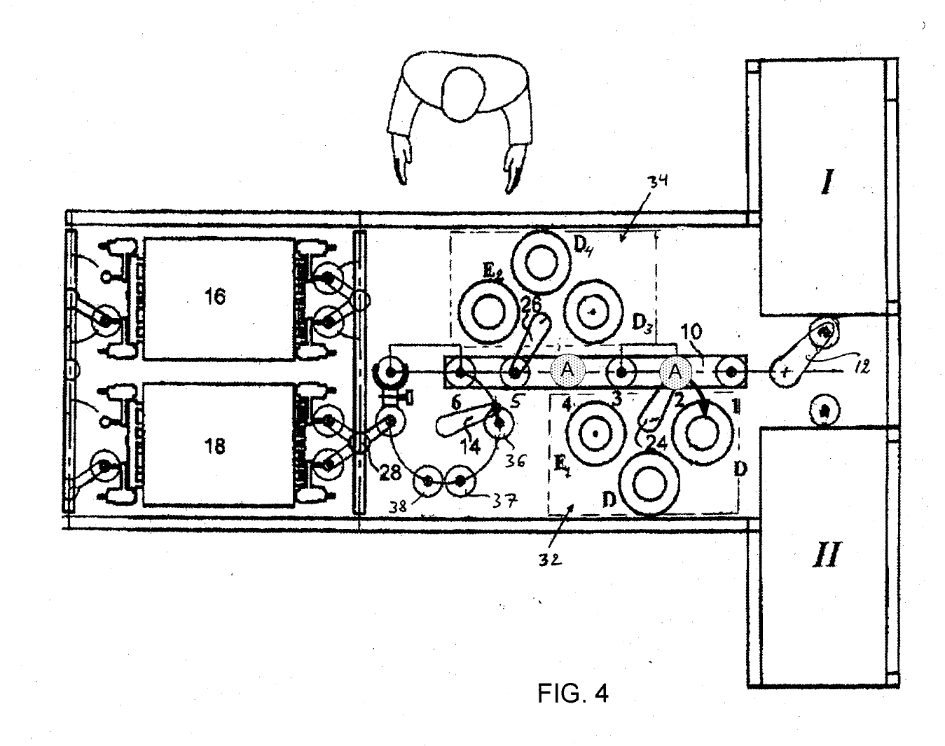

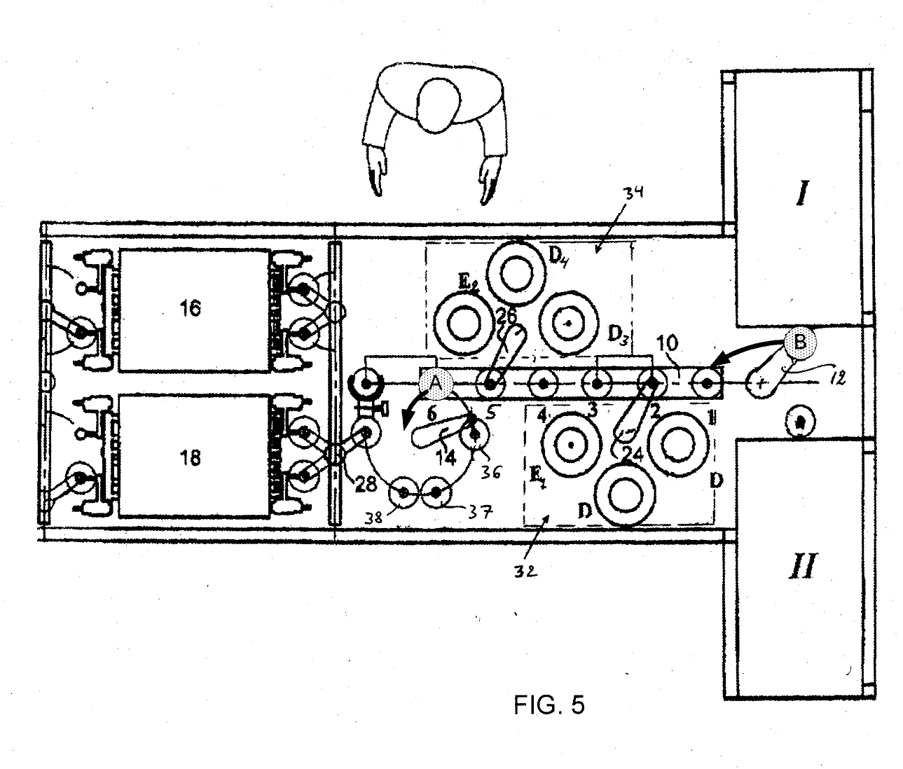

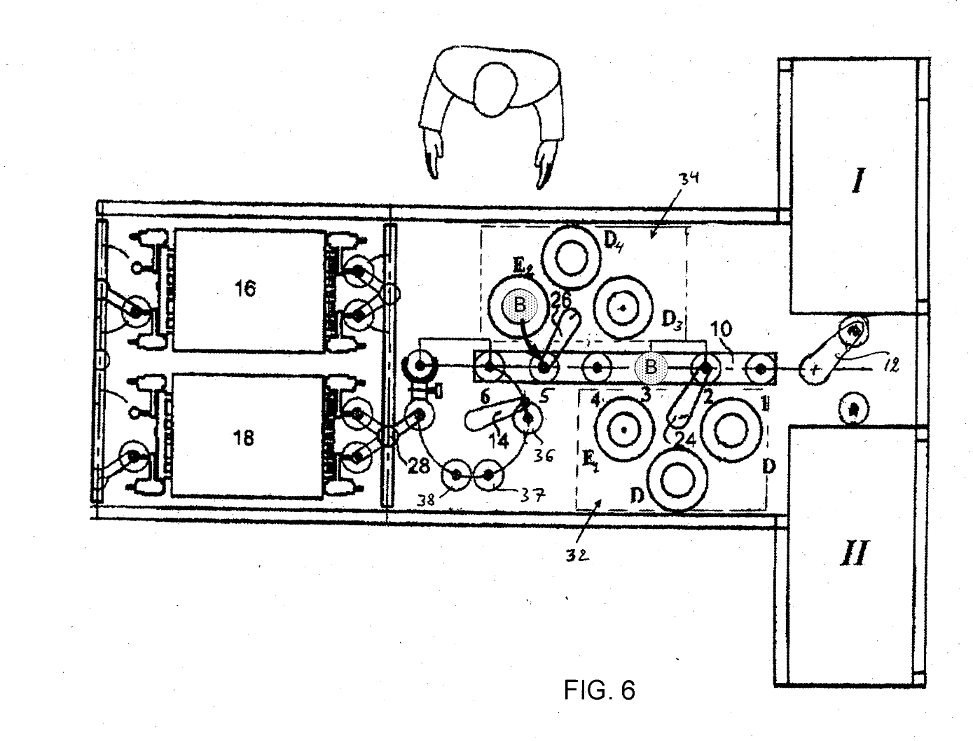

FIGS. 3 to 6 depict the occupancy of the various positions 1-6 on the linear transport device 10 and on the processing stations 32, 34 with A and B substrates, respectively, during the first processing cycle (FIG. 3), the second processing cycle (FIG. 4), the third processing cycle (FIG. 5), and the fourth processing cycle (FIG. 6), as described in table form in FIG. 2. The movement of the substrates between respective positions on the linear transport device 10 and the processing stations 32, 34 is indicated by arrows.

Accordingly, the method of the invention requires only four single steps and double steps to transport substrates from the loading position via the respective processing stations to the withdrawal position. A transport in single steps would require six steps.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for producing optical data carriers with first and second substrates produced in two injection molding machines, said method comprising the steps of transporting the first and second substrates from the injection molding machines by a single linear transport system, which operates in a step-wise fashion, to a first processing station for processing the first substrates, to a second processing station for processing the second substrates, and to at least one third processing station for further processing the first and second substrates, wherein the transport system is operated by a sequence of single, double or multiple steps.

2. The method of claim 1, wherein, as viewed in the transport direction of the transport system, the first and the second processing stations are arranged sequentially, wherein a first substrate is loaded in the transport system, a single step is performed followed by a double step, a second substrate is loaded in the transport system, and a double step is performed followed by a single step.

3. The method of claim 1, wherein the transport system has six positions for receiving substrates and the transport system is loaded and unloaded in four repeating operating cycles, wherein a first position represents a loading position, a second position represents a withdrawal position for the first processing station, a third position represents a loading station from the first processing station, a fourth position represents a withdrawal position for the second processing station, a fifth position represents a loading position from the second processing station and a sixth position represents a withdrawal position, wherein in a first operating cycle the first and third positions are loaded, the fourth and sixth positions are unloaded, followed by a single step, wherein in a second operating cycle the second position is unloaded, followed by a double step, wherein in a third operating cycle, the first position is loaded and the sixth position is unloaded, followed by a double step, and wherein in a fourth operating cycle, the fifth position is loaded, followed by a single step.

4. A device for transporting substrates for producing optical data carriers made of two substrates produced by two injection molding machines, comprising a linear transport system operating stepwise for transporting the substrates from the injection molding machines to a first processing station, in which the first substrates are processed, to a second processing station, in which the second substrates are processed, to at least one additional processing station, in which the substrates are further processed, wherein the transport system is configured for operation with a sequence of single and double or multiple steps.

5. The device of claim 4, wherein the transport system is a walking beam system.

6. The device of claim 4, and further including two coating stations.

7. The device of claim 6, wherein the coating stations are arranged on different sides of the transport system and the processing stations are sequentially arranged in a transport direction of the transport system.
